(19) United States
(12) Patent Application Publication
(10) Pub. No.: US 2013/0333204 A1
(43) Pub. Date: Dec. 19, 2013

(54) METHOD OF MANUFACTURING HARD DISK DRIVE DEVICE AND HARD DISK DRIVE DEVICE

(71) Applicant: Samsung Electro-Mechanics Japan Advanced Technology Co., Ltd., Shizuoka (JP)

(72) Inventors: Kenji Nishihara, Shizuoka (JP); Winya Dungkaew, Nakhon Ratchasima (TH); Masayuki Ishikawa, Shizuoka (JP)

(73) Assignee: Samsung Electro-Mechanics Japan Advanced Technology Co., Ltd., Shizuoka (JP)

(21) Appl. No.: 13/917,264

(22) Filed: Jun. 13, 2013

(30) Foreign Application Priority Data
Jun. 15, 2012 (JP) 2012-135471

(51) Int. Cl. B08B 3/04

(52) U.S. Cl. CPC B08B 3/04
USPC 29/603.03

(57) ABSTRACT

An embodiment of the present invention is a method of manufacturing a hard disk drive device including a hub member on which a recording disk is to be mounted and a base member configured to rotatably support the hub member via a bearing part. When constituent members including the base member, the hub member, and the bearing part are referred to as works, the manufacturing method includes: cleaning at least one of the works with a cleaning agent containing at least one of an ester and an ether, and a surfactant; and assembling the hard disk drive device by using the work having been subjected to the cleaning.

The present application claims the benefit of Japanese Patent Application No. 2012-135471 filed Jun. 15, 2012. The disclosure of this application is hereby incorporated in its entirety by reference as if fully set forth herein.

### BACKGROUND OF THE INVENTION

1. Field of the Invention

The present invention relates to a method of manufacturing a hard disk drive device and a hard disk drive device manufactured by the method.

2. Description of the Related Art

In recent years, the rotational accuracy of rotating devices, such as hard disk drive devices and optical disk drive devices, has been drastically improved by being provided with fluid dynamic bearing units. With the improvement, the rotating devices are required to have higher densities and larger capacities. For example, in a hard disk drive device for magnetically recording data, read/write of data is performed by a magnetic head tracing, with a slight flying gap, a recording disk on which recording tracks are formed, while the recording disk is rotating at high speed. It is needed to make the width between the recording tracks to be narrow in order that such a hard disk drive device has a high density and a large capacity. In addition, as the width therebetween becomes narrower, it is needed to make the gap between the magnetic head and the recording disk to be further narrower. There is the demand that, when the reliability in reading/writing data is taken into consideration, the flying gap is made to be extremely narrow, for example, 10 nm or less. Accordingly, the dimension of a part that forms the hard disk drive device and the flatness of the surface of the part are required to be highly accurate.

In addition, magnetoresistance effect elements (hereinafter, each referred to as an MR element) are mostly used in the magnetic heads for the purpose of high capacity. On the other hand, when an MR element is used for an extremely narrow flying gap, occurrence of a thermal asperity failure (hereinafter, referred to as a TA failure) or a head crash failure becomes more serious. Due to the kinetic energy occurring when a foreign substance on the surface of a disk contacts the MR element while a magnetic head is tracing in a floating manner, momentary heat is generated in the MR element. The TA failure is one in which the resistance of the MR element is momentarily varied with the MR element being heated or cooled momentarily, so that the variation is superimposed on a reproduced signal as noise, thereby causing a decrease in the accuracy of reading the reproduced signal.

As a result of intensive study, the present inventors have acquired the knowledge that an event, in which a decrease in the reliability in reading/writing data, such as a TA failure, is caused, is generated with a foreign substance (hereinafter, collectively referred to as a Particle), which has been attached to a rotating device, moving to the surface of a recording disk. Also, in an optical disk drive device, an example of the rotating device, if a Particle is attached to the surface of a recording disk, the read/write of a recording signal is hampered in the area to which the Particle is attached, thereby causing a decrease in the reliability in reading/writing data.

On the other hand, each of Japanese Patent Application Publications Nos. 2012-050212, 2011-165286, 2011-123984, and 2010-244627 discloses a method of manufacturing a rotating device including cleaning a member that forms the rotating device.

The present inventors have found that the attachment of a Particle to the surface of a recording disk occurs in the following way. That is, the constituent parts of a rotating device are mostly manufactured through cutting processing. For example, the desired shape and dimension of a hub, on which a recording disk is mounted and which rotates at high speed, are secured by cutting a metal material. In the case of cutting processing, it is generally performed that: a cutting agent, such as cutting oil, is supplied between a material and a cutting tool to reduce a cutting resistance during cutting; and thereby improvement in the processing accuracy and a reduction in the damage of the material or the cutting tool are achieved. If a rotating device is assembled in a state in which the cutting agent is being attached to a constituent part, a residual cutting agent component becomes a Particle. The cutting agent component volatilizes and migrates in the rotating device over time, which is sometimes attached to the recording surface of a recording disk.

Even in the aforementioned conventional method of manufacturing a rotating device, the cleanliness level can be enhanced to some extent by cleaning a constituent part to remove an attached cutting agent component. However, as the capacities of rotating devices are being made larger in recent years, the constituent part are required to have higher cleanliness levels. In such a situation, the present inventors have recognized that, an amount of residual cutting agent components, which is acceptable for, e.g., an optical disk drive device, an example of rotating devices, is sometimes unacceptable for a hard disk drive device.

That is, in an optical disk drive device, the atmosphere in the drive device in which a disk is placed (hereinafter, the atmosphere appropriately referred to as a “disk atmosphere”) is opened to the ambient air of the drive device. Accordingly, even if a cutting agent component is diffused in the disk atmosphere, the cutting agent component swiftly spreads into the ambient air of the drive device. In addition, a recording disk is put into/out of an optical disk drive device, and it is extremely rare that the recording disk is placed in the disk atmosphere permanently. Accordingly, a cutting agent component is hardly attached to the surface of the recording disk. On the other hand, in the case of a hard disk drive device, the disk atmosphere is a closed space, and hence a cutting agent component diffused in the disk atmosphere remains therein without spreading into the ambient air. And, the content of the cutting agent component in the disk atmosphere is increased overtime. Further, a recording disk is not put into/out of the drive device and is placed in the disk atmosphere permanently. Accordingly, the cutting agent component is likely to be attached to the surface of the recording disk.

Further, the recording density of a hard disk drive device is higher than that of an optical disk drive device by two orders of magnitude or more. In addition, the distance between the head and the surface of a recording disk in an optical disk drive device is, for example, approximately 0.1 to 1 mm, while that in a hard disk drive device is as extremely narrow as approximately 0.1 nm. Accordingly, a hard disk drive device is likely to be more influenced by a Particle attached to the surface of a recording disk.

### SUMMARY OF THE INVENTION

The present invention has been made in view of these situations, and a purpose of the invention is to provide a technique in which the cleanliness level of a constituent part of a hard disk drive device is enhanced.

An embodiment of the present invention is a method of manufacturing a hard disk drive device. This method is a method of manufacturing a hard disk drive device including a hub member on which a recording disk is to be mounted and a base member configured to rotatably support the hub member via a bearing part, and when constituent members including the base member, the hub member, and the bearing part are referred to as works, the method comprises: cleaning at least one of the works by using a cleaning to agent containing at least one of an ester and an ether, and a surfactant in a mass ratio of the total of the ester and the ether to the surfactant of 1:1 to 1:4, in which at least one of a fatty acid and a fatty acid ester, and a hydrocarbon, which are attached to the at least one of the works, are removed; and assembling the is hard disk drive device by using the work having been subjected to the cleaning.

Another embodiment of the present invention is also a method of manufacturing a hard disk drive device. This method is a method of manufacturing a hard disk drive device including a hub member on which a recording disk is to be mounted and a base member configured to rotatably support the hub member via a bearing part, and when constituent members including the base member, the hub member, and the bearing part are referred to as works, the method comprises: cleaning at least one of the works with a cleaning agent containing at least one of an ester and an ether, and a surfactant; and assembling the hard disk drive device by using the work having been subjected to the cleaning.

Still another embodiment of the present invention is also a method of manufacturing a hard disk drive device. This method is a method of manufacturing a hard disk drive device including a hub member on which a recording disk is to be mounted and a base member configured to rotatably support the hub member via a bearing part, and when constituent members including the base member, the hub member, and the bearing part are referred to as works, the method comprises: cleaning at least one of the works by removing at least one of a fatty acid and a fatty acid ester, and a hydrocarbon, which are attached to the at least one of the works; and assembling the hard disk drive device by using the work having been subjected to the cleaning.

Still another embodiment of the present invention is a disk drive device. This hard disk drive device comprises: a hub member on which a recording disk is to be mounted; and a base member configured to rotatably support the hub member via a bearing part, and is manufactured by using the method of manufacturing a hard disk drive device according to any one of the aforementioned embodiments.

Optional combinations of the aforementioned constituting elements and implementations of the invention in the form of methods, apparatuses, or system may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view explaining the internal structure of a hard disk drive device manufactured by a manufacturing method according to an embodiment;

FIG. 2 is a plan view illustrating the outline of a state of a subassembly in a hard disk drive device manufactured by a manufacturing method according to the present embodiment, in which a bearing unit and a rotating body part including a hub member, etc, is assembled to a base member;

FIG. 3 is a sectional view, taken along the M-N line in FIG. 2;

FIG. 4 is a view explaining manufacture of a work in a method of manufacturing a hard disk drive device according to an embodiment;

FIG. 5A is a chart showing a result of analyzing a sample, cleaned with a cleaning agent solution of Example 1, by gas chromatography/mass spectrometry;

FIG. 5B is a chart showing a result of analyzing a sample, cleaned with a cleaning agent solution of Example 2, by gas chromatography/mass spectrometry;

FIG. 5C is a chart showing a result of analyzing a sample, cleaned with a cleaning agent solution of Example 3, by gas chromatography/mass spectrometry;

FIG. 5D is a chart showing a result of analyzing a sample, cleaned with a cleaning agent solution of Comparative Example, by gas chromatography/mass spectrometry; and

FIG. 5E is a chart showing a result of analyzing a non-cleaned sample by gas chromatography/mass spectrometry.

### DETAILED DESCRIPTION OF THE INVENTION

The invention will now be described by reference to the preferred embodiments. This does not intend to limit the scope of the present invention, but to exemplify the invention.

Hereinafter, preferred embodiments of the present invention will de described based on the accompanying drawings. The same or equivalent constituting elements and members illustrated in each drawing shall be denoted by the same reference numerals, and duplicative explanations will be omitted. Dimensions of members illustrated in each drawing are appropriately enlarged or reduced for easier understanding. Part of members not important for describing the embodiment are omitted from each drawing.

The development in which preferred embodiments of the present invention have been acquired will be first described. The present inventors have acquired the knowledge that, with a drastic increase in the capacity of a hard disk drive device, for example, from 500 GB to 1 TB per a disk, an amount of cutting agent components, the components remaining in a constituent part, is required to be lowered to 1/20 or less of the conventional one. That is, if the cleanliness level of a constituent part is similar to that of a conventional constituent part, there have been the cases in each of which read/write of a recording signal is hampered because the head for reading/writing signals moves onto an area of the surface of a disk of the hard disk drive device, to which a Particle have been attached. In addition, as a result of intensive study with respect to cutting agent components that are attached to constituent parts of a hard disk drive device, the inventors have found that: the cutting agent components, which remain in a constituent part, include, in addition to a hydrocarbon, a fatty acid ester and a fatty acid created by hydrolysis of the fatty acid ester; and the fatty acid ester and the fatty acid remain in a constituent part of a hard disk drive device and they are then attached to the surface of a recording disk by dispersion or evaporation-condensation, thereby causing a failure for making the hard disk drive device have a large capacity. Also, the inventors have found that: because a conventional cleaning agent used for cleaning constituent parts contains a surfactant, as a major agent, and an alcohol-based solvent, as a cosolvent, the fatty acid ester and the fatty acid are not fully removed. From the above knowledge, the inventors have developed preferred embodiments of the present invention.

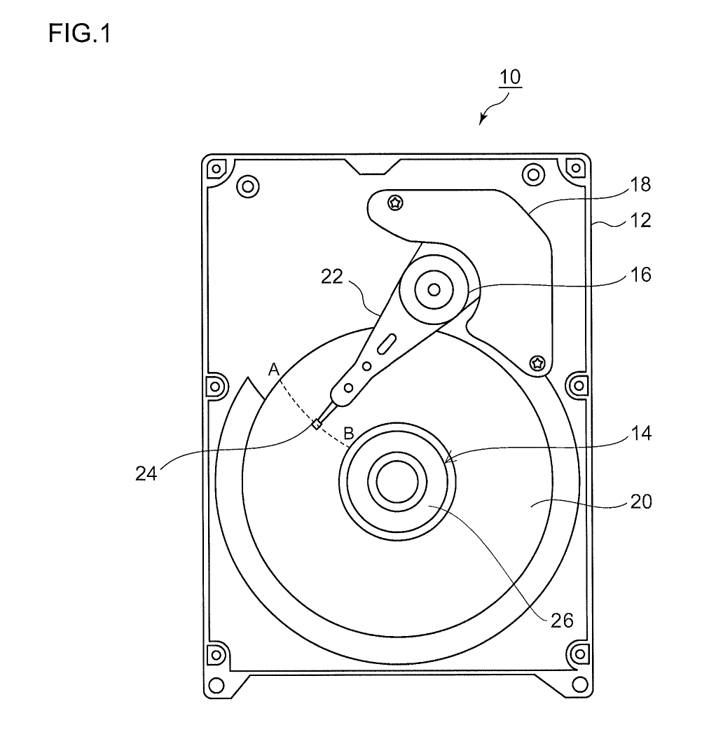

Subsequently, the structure of a hard disk drive device manufactured by a manufacturing method according to the present embodiment will be described. FIG. 1 is a view explaining the internal structure of a hard disk drive device manufactured by the manufacturing method according to an embodiment. FIG. 1 illustrates a state in which a cover has been removed to expose the internal structure. Hereinafter, description will be made, assuming that the side in which a recording disk 20 is mounted with respect to a base member 12 is the upper side of a hard disk drive device 10.

The hard disk drive device 10 includes, as major members, a hub member 26 on which the recording disk 20 is to be mounted and the base member 12 configured to rotatably support the hub member 26 via a bearing part. In more detailed description, a brushless motor 14, an arm bearing part 16, and a voice coil motor 18, etc, are mounted on the upper surface of the base member 12. The brushless motor 14 supports, on its axis, the hub member 26 on which the recording disk 20 is to be mounted, and rotationally drives the recording disk 20 on which data can be recorded, for example, magnetically. The brushless motor 14 can be replaced by, for example, a spindle motor. The brushless motor 14 is driven by a three-phase drive current consisting of a U-phase, a V-phase, and a W-phase.

The arm bearing part 16 swingably supports a swing arm 22 within a movable range AB. The voice coil motor 18 makes the swing arm 22 swing in accordance with external control data. A magnetic head 24 is attached to the tip of the swing arm 22. When the hard disk drive device 10 is in an operating state, the magnetic head 24 moves, with the swing of the swing arm 22, within the movable range AB and above the surface of the recording disk 20 via a slight gap between the surface of the recording disk 20 and the magnetic head 24, thereby reading/writing data. In FIG. 1, the point A corresponds to a position at the outermost recording track of the recording disk 20 and the point B to a position at the innermost recording track thereof. The swing arm 22 may be transferred to a waiting position provided on the side of the recording disk 20 when the hard disk drive device 10 is in a stopped state.

In the present embodiment, a device including all of the parts for reading/writing data, such as the recording disk 20, the swing arm 22, the magnetic head 24, and the voice coil motor 18, etc., is sometimes expressed as the hard disk drive device 10, or only the part for rotationally driving the recording disk 20 is sometimes expressed as the disk drive device 10.

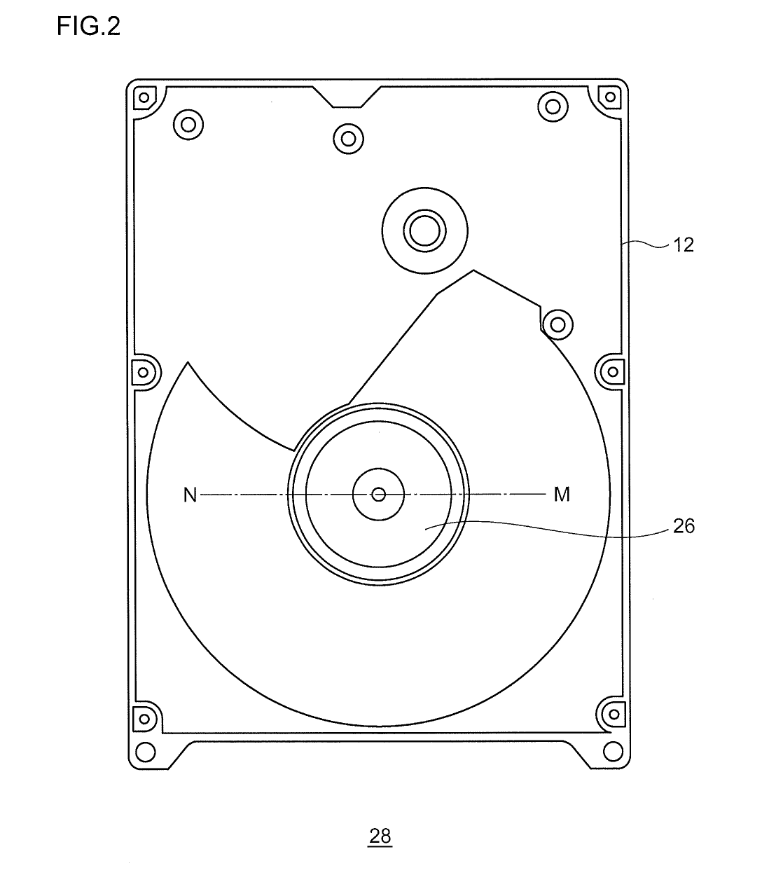

FIG. 2 is a plan view illustrating the outline of a state of a subassembly in a hard disk drive device manufactured by a manufacturing method according to the present embodiment, in which a bearing unit and a rotating body part including a hub member, etc., is assembled to a base member. In the embodiment, the hard disk drive device 10 is completed by attaching the recording disk 20, the magnetic head 24, the swing arm 22, the arm bearing part 16, the voice coil motor 18, and a cover for covering the whole of these parts to this subassembly 28.

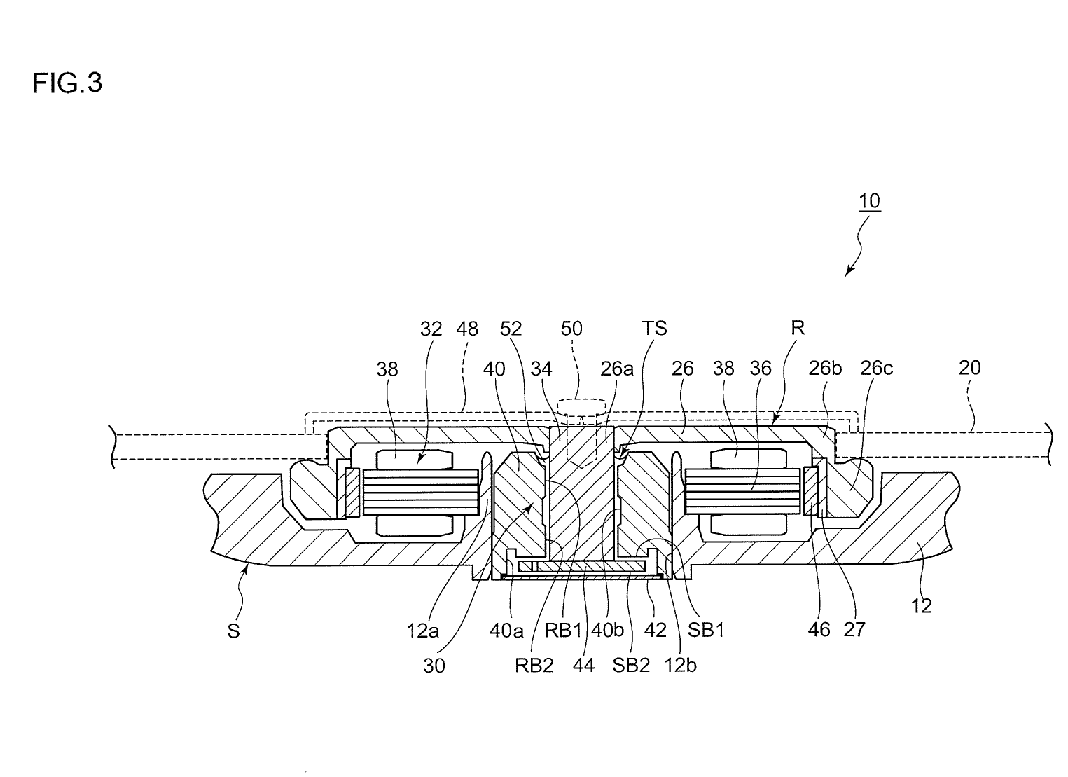

FIG. 3 is a sectional view, taken along the M-N line in FIG. 2. The hard disk drive device 10 according to the present embodiment is formed by a fixed body part S, a rotating body part R, a bearing unit 30 as a bearing part, and a drive unit 32. The bearing unit 30 includes both a radial fluid dynamic bearing part formed by radial dynamic pressure grooves RB1 and RB2 and a lubricant, and a thrust fluid dynamic bearing part formed by thrust dynamic pressure grooves SB1 and SB2. The drive unit 32 rotationally drives the rotating body part R via these fluid dynamic bearing parts with respect to the fixed body part S. FIG. 3 illustrates, as an example, the structure of the so-called shaft-rotation-type hard disk drive device 10 in which the hub member 26 for supporting the recording disk 20 and a shaft 34 are is integrated with each other to rotate. Some of the constituent members of the hard disk drive device 10 are included in a plurality of groups among the groups functionally consisting of the fixed body part S, the bearing unit 30, the rotating body part R, and the drive unit 32. For example, the shaft 34 is included in both the rotating body part R and the bearing unit 30.

The fixed body part S is formed to include the base member 12, a stator core 36, a coil 38, a sleeve 40, and a counter plate 42. The stator core 36 is firmly adhered to the outer wall surface of a cylinder portion 12a formed in the base member 12. The sleeve 40 is a cylindrical part and is formed of a metal material or a resin material having conductivity. The outer circumferential surface of the sleeve 40 forms the outer circumferential surface of the bearing unit 30. The bearing unit 30 is fixed, for example, with an adhesive, etc., to a bearing hole 12b formed by the inner wall surface of the cylinder portion 12a in the base member 12. The disk-shaped counter plate 42 is firmly adhered to one of the edge portions of the sleeve 40, so that the inner side of the base member 12, in which the recording disk 20, etc., is housed, is sealed.

The base member 12 can be formed, for example: by performing epoxy resin coating on the surface of a base material (material) produced by aluminum die casting and then by cutting part of the base material; by subjecting an aluminum plate to press processing; or by subjecting a steel plate to press processing and then by performing nickel plating thereon. The stator core 36 can be formed by laminating a plurality of magnetic plate materials, such as silicon steel plates, and then by performing insulation coating, such as electro-deposition coating and powder coating, on the surface thereof. The stator core 36 is a ring-shaped member having a plurality of salient poles (not illustrated) each protruding radially outward and being wound around with the coil 38. When the hard disk drive device 10 is, for example, three-phase driven, the number of the salient poles is designed to be nine. The winding end of the coil 38 is soldered onto an FPC (not illustrated) arranged on the base of the base member 12.

The rotating body part R is formed to include the hub member 26, a yoke 27, the shaft 34, a flange 44, and a magnet 46. The hub member 26 is an approximately cup-shaped member, and has a center hole 26a, an outer circumferential cylinder portion 26b concentric with the center hole 26a, and an outer extending portion 26c extending outward at the lower end of the outer circumferential cylinder portion 26b. The ring-shaped yoke 27 is firmly adhered to the inner wall surface of the outer extending portion 26c, and the ring-shaped magnet 46 is firmly adhered to the inner wall surface of the yoke 27. The hub member 26 can be formed by cutting a metal, such as stainless steel, aluminum, iron, or the like. The yoke 27 can be formed of a magnetic material, such as iron. The yoke 27 is fixed, by adhesion and press-fitting, etc., to the inner circumferential surface of the outer extending portion 26c of the hub member 26. The magnet 46 is formed, for example, of a Nd—Fe—B (neodymium-iron-boron) material, and an anti-rust treatment using electro-deposition coating or spray coating is performed on the surface thereof. In the present embodiment, the inner circumference of the magnet 46 is magnetized, for example, in 12 poles. The magnet 46 is fixed, by adhesion, to the inner circumferential surface of the yoke 27. Accordingly, it can be said that the magnet 46 is fixed to the hub member 26 via the yoke 27.

One end of the shaft 34 is fixed to the center hole 26a formed in the hub member 26, and the disk-shaped flange 44 is fixed to the other end thereof. The shaft 34 can be formed of a metal having conductivity, such as, for example, stainless steel. The flange 44 can be formed of a metal material or a resin material having conductivity. A flange housing space portion 40a, in which the flange 44 is housed, is formed at one end of the sleeve 40. Accordingly, the sleeve 40 supports the shaft 34 to which the flange 44 is fixed in a space encompassed by a cylinder inner wall surface 40b and the flange housing space portion 40a such that a relative rotation of the shaft 34 is allowed.

The shaft 34 having the flange 44 of the rotating body part R is inserted along the cylinder inner wall surface 40b of the sleeve 40 of the fixed body part S. As a result of that, the rotating body part R is rotatably supported by the fixed body part S via both the radial fluid dynamic bearing part formed by the radial dynamic pressure grooves RB1 and RB2 and a lubricant and the thrust fluid dynamic bearing part formed by the thrust dynamic pressure grooves SB1 and SB2 and a lubricant. The drive unit 32 is formed to include the stator core 36, the coil 38, and the magnet 46. In this case, the hub member 26 forms a magnetic circuit with the stator core 36 and the magnet 46. Accordingly, the rotating body part R is rotationally driven by sequentially powering each coil 38 with a drive circuit externally provided being controlled.

In the present embodiment, the outer circumferential cylinder portion 26b of the hub member 26 engages with the center hole of the recording disk 20, and the outer extending portion 26c positions and supports the recording disk 20. A clamper 48 is mounted on the upper surface of the recording disk 20, and the clamper 48 is fixed to the hub member 26 by a screw 50. Thereby, the recording disk 20 is integrally fixed to the hub member 26, so that the recording disk 20 can rotate along with the hub member 26.

The bearing unit 30, as a bearing part, is formed to include the shaft 34, the flange 44, the sleeve 40, and the counter plate 42. Accordingly, the shaft 34, the flange 44, the sleeve 40, and the counter plate 42 correspond to the constituent members of the bearing part. The cylinder inner wall surface 40b of the sleeve 40 and the outer circumferential surface of the shaft 34, the outer circumferential surface facing the cylinder inner wall surface 40b, form a radial space portion. The radial dynamic pressure grooves RB1 and RB2, by which a dynamic pressure for supporting the shaft 34 in a radial direction is generated, are formed on at least one of the cylinder inner wall surface 40b of the sleeve 40 and the outer circumferential surface of the shaft 34. The radial dynamic pressure groove RB1 is formed on the side near to the hub member 26, while the radial dynamic pressure groove RB2 is formed on the side farther than the radial dynamic pressure groove RB1 away from the hub member 26. The radial dynamic pressure grooves RB1 and RB2 are, for example, herringbone-shaped or spiral-shaped grooves that are isolated and arranged in the axial direction of the shaft 34. The radial space portion is filled with a lubricant 52, such as oil. Accordingly, when the shaft 34 rotates, a portion where the lubricant 52 has a high pressure is generated in the lubricant 52. The shaft 34 is spaced apart from the surrounding wall surface by the pressure, thereby allowing the shaft 34 to be in a rotational state in which the shaft 34 is in a substantially non-contact state in the radial direction.

The flange 44 that rotates integrally with the shaft 34 is fixed to the lower end of the shaft 34. The flange housing space portion 40a, in which the flange 44 is rotatably housed, is formed in the central portion of the lower surface of the sleeve 40. One end of the flange housing space portion 40a is sealed by the counter plate 42. Thereby, it is designed that the airtight in the flange housing space portion 40a and the successive housing space of the shaft 34 can be maintained.

The thrust dynamic pressure groove SB1 is formed on at least one of the surfaces of the flange 44 and the sleeve 40, is the surfaces facing each other in the shaft axial direction. The thrust dynamic pressure groove SB2 is formed on at least one of the surfaces of the flange 44 and the counter plate 42, the surfaces facing each other in the same direction as stated above. The thrust fluid dynamic bearing part is formed by the cooperation between the thrust dynamic pressure grooves SB1 and SB2 and the lubricant 52. Each of the thrust dynamic pressure grooves SB1 and SB2 is formed, for example, into a spiral shape or a herring bone shape, and generates a pump-in dynamic pressure. That is, a pump-in dynamic pressure is generated with the flange 44, included in the rotating body part R, rotating with respect to the sleeve 40 and the counter plate 42, included in the fixed body part S. As a result of the generation of a dynamic pressure, the rotating body part R including the flange 44 is made, by this dynamic pressure, to be in a substantially non-contact state with a predetermined gap in the axial direction with respect to the fixed body part S, thereby allowing the rotating body part R including the hub member 26 to be supported in a non-contact state with respect to the fixed body part S.

In the present embodiment, the lubricant 52, injected into the gap in each of the radial fluid dynamic bearing part and the thrust fluid dynamic bearing part, is shared. The open end side of the sleeve 40 forms a capillary seal portion TS in which the gap between the inner circumference of the sleeve 40 and the outer circumference of the shaft 34 gradually expands toward the outside. The space, including the radial dynamic pressure grooves RB1 and RB2 and the thrust dynamic pressure grooves SB1 and SB2, and the middle of the capillary seal portion TS are filled with the lubricant 52. The capillary seal portion TS prevents the lubricant 52 from leaking to the outside of the filled region due to capillarity.

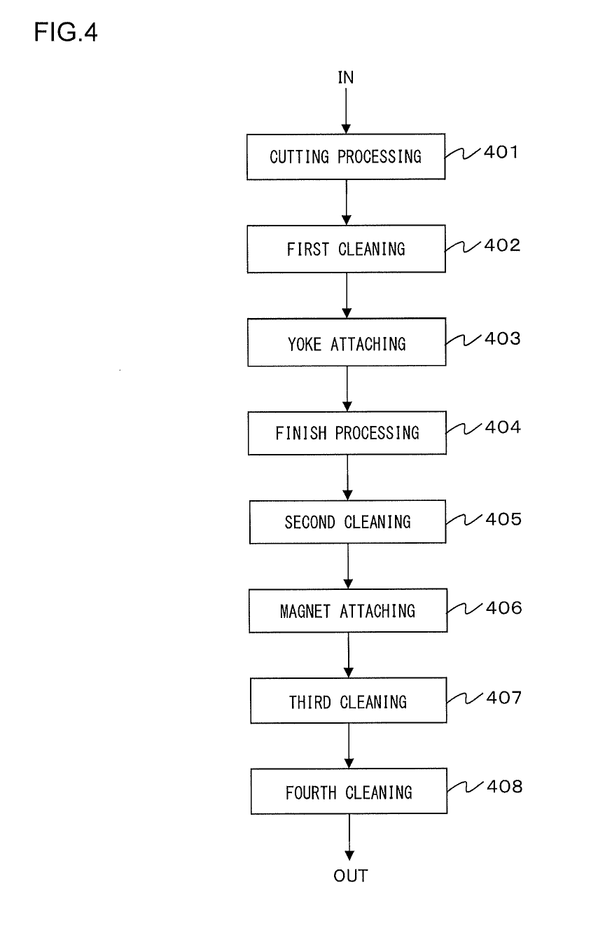

A method of manufacturing the hard disk drive device 10 having the aforementioned structure will be described. Hereinafter, constituent members including the base member 12, the hub member 26, and the bearing unit 30 are referred to as works. A method of manufacturing the hard disk drive device 10 according to the present embodiment comprises, as major steps: manufacturing a work; and assembling the hard disk drive device 10 by combining the manufactured works. Hereinafter, the manufacture of a work will be described by taking the hub member 26 as an example. FIG. 4 is a view explaining the manufacture of a work in the method of manufacturing a hard disk drive device according to an embodiment.

The manufacture of the hub member 26 as a work includes a cutting processing step 401, a first cleaning step 402, a yoke attaching step 403, a finish processing step 404, a second cleaning step 405, a magnet attaching step 406, a third cleaning step 407, and a fourth cleaning step 408.

In the cutting processing step 401, an unprocessed material made of cast aluminum, etc., is fed to the IN side. The material is cut into a predetermined shape while a cutting agent, such as water-soluble cutting oil, is being supplied, thereby allowing the hub member 26 to be formed. The cutting agent is used for: reducing the friction between a cutting machine and the material; cooling the cutting machine and the material; and removing scraps, etc. The cutting agent contains a hydrocarbon, a fatty acid ester, and a surfactant for emulsifying the hydrocarbon. In the cutting processing step 401, the cutting of the material is performed by fixing the material to the chucks of the cutting machine and by supplying, from a nozzle, the cutting agent to an area where a cutting tool and the material are in contact with each other.

Following the cutting processing step 401, the first cleaning step 402 is performed. In the first cleaning step 402, cleaning is performed by using pure water, in which shower cleaning or immersion cleaning using a cleaning tank is performed alone or in combination. Alternatively, ultrasonic cleaning may be performed by generating ultrasonic waves in a cleaning tank. In the present embodiment, after being subjected to shower cleaning with pure water, a work is sequentially immersed in a plurality of cleaning tanks that are filled with pure water having a temperature of 40 to 45° C. for 10 to 20 minutes in each tank to apply ultrasonic waves having a frequency of 40 kHz. Thereafter, the work is dried by blowing warm air against it. Alternatively, natural drying or vacuum drying may be used for drying the work.

Following the first cleaning step 402, the yoke attaching step 403 is performed. In the yoke attaching step 403, the yoke 27 is fixed, by adhesion and press-fitting, to the inner circumferential surface of the outer extending portion 26c of the hub member 26. For example, an epoxy thermosetting adhesive can be used for the adhesion of the yoke 27. In the present embodiment, the yoke 27 is press-fitted into the hub member 26 after an adhesive is applied onto the inner circumferential surface of the outer extending portion 26c of the hub member 26 and/or the yoke 27. Subsequently, the adhesive is cured by heating at 80° C. for 30 minutes. Thereby, the yoke 27 can be attached to the hub member 26. Following the yoke attaching step 403, the finish processing step 404 is performed. In the finish processing step 404, for the purposes of balancing the hub member 26 and enhancing the flatness thereof, the hub member 26 is cut while a cutting agent is being supplied in the same way as in the cutting processing step 401.

Following the finish processing step 404, the second cleaning step 405 is performed. As a result of various experiments, the present inventors have obtained the conclusion that: in order to make the hard disk drive device 10 have a large capacity, it is effective to reduce both an attached amount of fatty acid esters derived from the cutting agent remaining in a work and an attached amount of fatty acids created from the fatty acid esters, in addition to an attached amount of hydrocarbons similarly derived from the cutting agent remaining in the work. And, the inventors have found that, in order to remove the fatty acid esters and the fatty acids from the surface of a work, it is effective to clean the work by using a specific cleaning agent. Accordingly, in the second cleaning step 405, cleaning of a work, in which a cleaning agent containing at least one of an ester and an ether, and a surfactant (hereinafter, appropriately referred to as a “cleaning agent of the present embodiment”) is used, is performed. The dissolution of a fatty acid ester and/or a fatty acid into a cleaning agent solution, the fatty acid ester and the fatty acid remaining on the surface of the work, can be facilitated with the cleaning agent containing at least one of an ester and an ether. As a result, at least one of a fatty acid and a fatty acid ester that are attached to a work can be efficiently removed. Each of an ester and an ether is in a state of being bound to a hydrophobic group of a surfactant in the cleaning agent, which makes a fatty acid ester and a fatty acid that are firmly adhered to the surface of a work to be likely to be adsorbed to the hydrophobic group of a surfactant.

Of the hydrocarbons remaining on the surface of a work, a hydrocarbon having a relatively large molecular weight and a high melting point (hereinafter, appropriately referred to as a “high melting point hydrocarbon”) is in a wax state at normal temperature and is firmly adhered to the surface of the work, the removal efficiency of which is low when a conventional cleaning agent containing an alcohol-based solvent is used. On the other hand, these high melting point hydrocarbons can also be efficiently removed from the surface of a work by dissolving in a cleaning agent solution with the use of the cleaning agent of the present embodiment. In addition, with the cleaning agent of is the present embodiment, a hydrocarbon having a melting point lower than that of a high melting point hydrocarbon can also be dissolved and removed in the same way as a conventional cleaning agent. The aforementioned “high melting point hydrocarbon” is a hydrocarbon having, for example, 18 to 40 carbons. Examples of the high melting point hydrocarbon are shown in Table 1. A fatty acid to be cleaned is one having, for example, 18 to 40 carbons in an alkyl group that forms the main chain; and a fatty acid ester to be cleaned is one including this fatty acid. In addition, the melting point of a hydrocarbon having more than 40 carbons is sufficiently high, and it is rare that the temperature of a work exceeds the melting point in a normal operation of the hard disk drive device 10. Accordingly, the migration of the hydrocarbon from the surface of a work to the surface of a recording disk hardly occurs. Therefore, even if a hydrocarbon having more than 40 carbons remains on the surface of a work, an influence on the hard disk drive device 10 is actually small.

TABLE 1
[HIGH MELTING POINT HYDROCARBON]

| NUMBER OF | | MELTING | |
|---|---|---|---|
| CARBONS | NAME | POINT (° C.) | |
| 18 | OCTADECANE | 28.2° | C. |
| 19 | NONADECANE | 32~34° | C. |
| 20 | EICOSANE | 36.7° | C. |
| 21 | HENICOSANE | 40.5° | C. |
| 22 | DOCOSANE | 42~45° | C. |
| 23 | TRICOSANE | 46~47° | C. |
| 24 | TETRACOSANE | 49~52° | C. |
| 25 | PENTACOSANE | 53~56° | C. |
| 26 | HEXACOSANE | 55~58° | C. |
| 27 | HEPTACOSANE | 58~60° | C. |
| 28 | OCTACOSANE | 57~62° | C. |
| 29 | NONACOSANE | 63~66° | C. |
| 30 | TRIACONTANE | 64~67° | C. |
| 31 | HENTRIACONTANE | 67~69° | C. |
| 32 | DOTRIACONTANE | 65~70° | C. |
| 33 | TRITRIACONTANE | 71~73° | C. |
| 34 | TETRATRIACONTANE | 72~75° | C. |
| 35 | PENTATRIACONTANE | 73~75° | C. |
| 36 | HEXATRIACONTANE | 74~76° | C. |
| 37 | HEPTATRIACONTANE | 77~79° | C. |
| 38 | OCTATRIACONTANE | 79~80° | C. |
| 39 | NONATRIACONTANE | 78~82° | C. |
| 40 | TETRATRIACONTANE | 80~84° | C. |

In the second cleaning step 405, cleaning of a work is performed by contacting the work with, for example, an aqueous solution containing the cleaning agent of the present embodiment. The contact of a work with the aqueous solution is performed by immersing the work into a cleaning tank filled with the aqueous solution. In the present embodiment, ultrasonic waves having a frequency of 40 kHz are applied to a work for 30 to 180 seconds while the work is being immersed in an aqueous solution containing the cleaning agent.

It is preferable that the cleaning agent contains an ester from the viewpoints that: a fatty acid, a fatty acid ester, and a high melting point hydrocarbon, which remain on the surface of a work, should be dissolved; and a surfactant and water should be mixed together. It is more preferable that the ester contained in the cleaning agent contains a fatty acid diester. A cutting agent component, which remains on the surface of a work, can be removed further efficiently with the cleaning agent containing a fatty acid diester. The fatty acid diester contained in the cleaning agent of the present embodiment can be exemplified by fatty acid dialkyl esters, such as 2-Methylpentanedioic acid dimethyl ester expressed by the following formula (1), Glutaric Acid Dimethyl Ester expressed by the following formula (2), and 2-Methylglutaric acid diethyl ester expressed by the following formula (3).

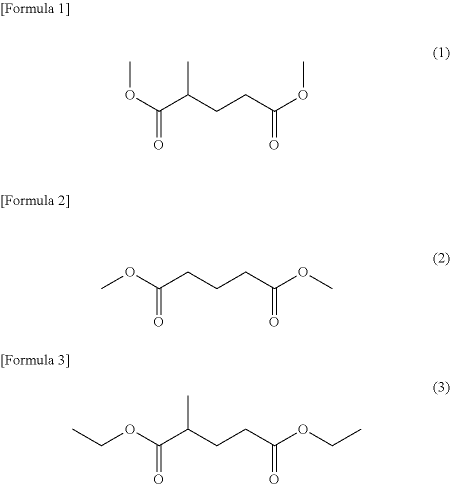

The ether contained in the cleaning agent can be exemplified, for example, by glycol ether. The glycol ether can be exemplified by dialkyl glycol ethers including diethylene glycol diethyl ether, etc.

It is preferable that each of the ester and the ether contained in the cleaning agent has a molecular weight of 118 to 188. By making the molecular weight of each of the ester and the ether to be 118 and more, the performance of the cleaning agent for removing a residual cutting agent component can be further enhanced. Further, by making the molecular weight of each of the ester and ether to be 188 or less, a decrease in the solubility of each of the ester and the ether into water can be suppressed, and a decrease in the concentration of each of the ester and the ether in a cleaning agent solution can be suppressed. Accordingly, the removal performance for a residual cutting agent component can be further enhanced. From experiments, the present inventors have confirmed that: by making the molecular weight of each of the ester and the ether to be within a range of 118 to 188, a cutting agent component remaining in a work can be more removed than before in the tact time of a conventional hard disk drive device; and even when it is intended that the hard disk drive device 10 has a large capacity, an increase in the read/write error can be suppressed.

It is preferable that the cleaning agent of the present embodiment contains at least one of an ester and an ether, and a surfactant in a mass ratio of the total of the ester and the ether to the surfactant of 1:1 to 1:4. By making, in the cleaning agent, a mass ratio of the total content of the ester and the ether to the content of the surfactant to be 1:1 or more, the ester and the ether can be dissolved into a cleaning agent solution further surely. In addition, by making the mass ratio to be 1:4 or less, a decrease in the concentration of the ester and the ether in the cleaning agent solution can be suppressed, thereby allowing a removal performance for a residual cutting agent component to be further enhanced. From experiments, the present inventors have confirmed that: by making, in the cleaning agent, a mass ratio of the total content of the ester and the ether and that of the surfactant to be 1:1 to 1:4, a cutting agent component remaining in a work can be further removed in the tact time of a conventional hard disk drive device; and even when it is intended that the hard disk drive device 10 has a large capacity, an increase in the read/write error can be suppressed.

It is preferable that the cleaning agent of the present embodiment further contains an organic acid. It can be considered that, when a work is made of a metal material, the metal that forms the work reacts with an alkali component in a cleaning agent to generate a hydroxide, etc. For example, when a work is made of aluminum or an alloy thereof, the surface of the work reacts with an alkali component in a cleaning agent to generate aluminum hydroxide or hydrated alumina (boehmite). Thereby, the surface thereof changes in color (becoming black). On the other hand, this change in color can be suppressed by containing an organic acid into the cleaning agent. That is, because an organic acid is functions as a pH adjuster, the pH of a cleaning agent solution is changed to the acid side by containing an organic acid into the cleaning agent. Thereby, a change in color, possibly occurring on the surface of a work, can be suppressed.

Examples of an organic acid to be used in the cleaning agent of the present embodiment include, for example: oxalic acid (C₂H₂O₄), acetic acid (C₂H₄O₂), lactic acid (C₃H₆O₃), malonic acid (C₃H₄O₄), malic acid (C₄H₆O₅), citric acid (C₆H₈O₇), and gluconic acid (C₆H₁₂O₇), etc. It is preferable that the content of an organic acid in the cleaning agent is 25 to 50 parts by mass based on 100 parts by mass of the total content of the ester and the ether in the cleaning agent. By making the content of an organic acid to be 25 parts by mass or more based on 100 parts by mass of the total content of the ester and the ether, a pH adjusting effect by the organic acid can be exerted further surely. In addition, by making the content of an organic acid to be 50 parts by mass or less based on 100 parts by mass of the total content of the ester and the ether, etching of the surface of a work, possibly occurring by the organic acid, can be suppressed further surely. From experiments, the present inventors have confirmed that: by making, in the cleaning agent, the content of an organic acid to be 25 to 50 parts by mass based on 100 parts by mass of the total content of the ester and the ether, a cutting agent component remaining in a work can be further removed in the tact time of a conventional hard disk drive device; and even when it is intended that the hard disk drive device 10 has a large capacity, an increase in the read/write error can be suppressed.

In the second cleaning step 405, it is preferable to clean a work by contacting the work with an aqueous solution containing the cleaning agent and having a temperature of 70° C. or lower. In addition, in the second cleaning step 405, a work is more preferably contacted with an aqueous solution of the cleaning agent having a temperature of 35 to 70° C., and still more preferably contacted with an aqueous solution thereof having a temperature of 35 to 55° C. By making the temperature of a cleaning agent solution to be 70° C. or lower, the heat resistance required of a cleaning apparatus or an ultrasonic transducer can be reduced, and hence simplification and space-saving of manufacturing facilities and a reduction in the manufacturing cost of the hard disk drive device 10, etc., can be made. Further, an effect of cleaning a work can be improved by enhancing the cavitation effect by the ultrasonic waves. Furthermore, the aforementioned change in color, possibly occurring on the surface of a work, can be further suppressed. Still furthermore, because an amount of the steam generated from a cleaning tank can be suppressed, a better factory environment can be maintained. Still furthermore, by making the temperature of a cleaning agent solution to be 35° C. or higher, the effect of cleaning the surface of a work by the cleaning agent of the present embodiment can be secured further surely.

When the temperature of a cleaning agent solution is lowered in order that, as stated above: the heat resistance required of cleaning apparatuses, etc, is reduced; the cleaning effect by ultrasonic waves is improved; a change in color, possibly occurring on the surface of a work, is suppressed; and a good factory environment is maintained, etc., a high melting point hydrocarbon, a fatty acid ester, and a fatty acid are likely to be solidified, and hence the effect of cleaning a work by a cleaning agent can be decreased. Accordingly, in a conventional alcohol-based cleaning agent, it has been difficult to lower the temperature of a cleaning agent solution. On the other hand, the cleaning agent of the present embodiment contains at least one of an ester and an ether and has a cleaning capability higher than that of a conventional one, and hence the cleaning effect by the cleaning agent can be maintained and the temperature of a cleaning agent solution can also be lowered.

The surfactant contained in the cleaning agent can be appropriately selected from conventionally- and publicly-known surfactants, such as an ester type, an ether type, and an ester ether type. Specific examples of the surfactant include, for example: Laureth-5 (Polyoxyethylene lauryl ether (C₂₂H₄₆O₆)) Laureth-7 (3,6,9,12,15-pentaoxaheptacosan-1-ol (C₂₅H₅₄O₈)), Laureth-9 (Nonaethylene glycol monododecyl ether (C₃₀H₆₂O₁₀)), and Laureth-12 (Ethoxylated Lauryl Alcohols (C₃₆H₇₄O₁₃)) etc.

It is preferable that, in the surfactant, the mole number of the added ethylene oxide is 5 to 12. By making the mole number of the added ethylene oxide to be 5 or more, an HLB value can be made to be 8 or more, thereby allowing an aqueous solution of the cleaning agent to be formed further stably by securing the solubility thereof into water. In addition, by making the mole number of the added ethylene oxide to be 12 or less, phase separation of the ester or the ether contained in the cleaning agent can be suppressed by securing the compatibility with the ester and ether. From experiments, the present inventors have confirmed that: by making the mole number of the added ethylene oxide in the surfactant to be 5 to 12, a cutting agent component remaining in a work can be more removed than before in the tact time of a conventional hard disk drive device; and even when it is intended that the hard disk drive device 10 has a large capacity, an increase in the read/write error can be suppressed.

Herein, the relationship between the temperature of a cleaning agent solution and the cloud point of a surfactant will be described. A surfactant having a cloud point lower than the temperature of a cleaning agent solution is generally used in a cleaning agent. Accordingly, when the temperature of a cleaning agent solution is lowered in order to improve the effect by ultrasonic waves, etc., as stated above, the required cloud point of a surfactant is also lowered. On the other hand, a surfactant having a low cloud point generally has a small molecular weight, and a surfactant having a small molecular weight has a low compatibility with an ester and an ether. Accordingly, phase separation is likely to be caused in a cleaning agent solution, and the cleaning effect by the cleaning agent is likely to be decreased. In addition, because it becomes difficult that the cutting agent component attached to a work is dissolved, a cleaning effect can be decreased. Conversely, when the temperature of a cleaning agent solution is raised, the required cloud point of a surfactant is also raised, and hence the phase separation in a cleaning agent solution can be prevented, and finally a decrease in the cleaning effect by the cleaning agent can be suppressed. In addition, because the cutting agent component attached to a work is likely to be dissolved, the cleaning effect can be improved. However, because an improvement of the effect by ultrasonic waves is suppressed, the cleaning effect can be decreased in terms of this point.

On the other hand, the present inventors have confirmed from experiments that: when the cleaning agent of the present embodiment is used, a good cleaning effect can be obtained under a temperature condition in which the cloud point of a surfactant is almost the same as or slightly higher than the temperature of the cleaning agent solution. With respect to the relationship between the temperature of a cleaning agent solution and the cloud point of a surfactant, when the temperature of a cleaning agent solution is within a range of 35° C. to 70° C., the cloud point of a surfactant is preferably made to be within a range of 40° C. to 65° C., and more preferably made to be within a range of 50° C. to 60° C. For example, when the temperature of a cleaning agent solution was 35° C. and a surfactant having a cloud point of 40° C. to 65° C. was used, a good cleaning effect was obtained. In addition, when the temperature of a cleaning agent solution was 35° C. and a surfactant having a cloud point of 50° C. to 60° C. was used, a better cleaning effect was obtained. In addition, it is preferable to use a surfactant having a cloud point of 52 to 58° C., when the temperature of a cleaning agent solution is 55° C.

Following the second cleaning step 405, the magnet attaching step 406 is performed. In the magnet attaching step 406, the magnet 46 is fixed, by adhesion, to the inner wall surface of the yoke 27. For example, an anaerobic, UV curable, acrylic adhesive can be used for the adhesion of the magnet 46. In the present embodiment, after an adhesion is applied to the inner circumferential surface of the yoke 72 and/or the magnet 46, the adhesive is cured by radiating UV rays for 30 minutes. Thereby, the magnet 46 is attached to the yoke 27. Following the magnet attaching step 406, the third cleaning step 407 is performed. In the third cleaning step 407, cleaning using pure water is performed, and from the cleaning to drying are performed in the same way as in the first cleaning step 402.

Following the third cleaning step 403, the fourth cleaning step 408 is performed. In the fourth cleaning step 408, the hub member 26, to which the yoke 27 and the magnet 46 have been attached, is cleaned by using a cleaning agent solution containing water as a solvent, a nonionic surfactant, and citric acid as a pH buffer agent, etc. In the present embodiment, the hub member 26 is immersed in a cleaning tank filled with the cleaning agent solution having a temperature of 65° C. for 1 to 3 minutes, and ultrasonic waves having a frequency of 40 kHz are applied thereto. Thereafter, the hub member 26 is dried. The dried hub member 26 is conveyed from the OUT side to an assembly step of the hard disk drive device 10.

Works other than the hub member 26 are also manufactured through the cutting processing step and the cleaning step, etc., respectively. For example, with respect to the base member 12, a material produced by aluminum die casting is cut to form the bearing hole 12b, etc. In addition, the base member 12 has both a tap hole for attaching the cover to the outer wall portion of the base member 12 and a tap hole for attaching the hard disk drive device 10 to another device by a screw, these tap holes being formed in the cutting processing step. After the cutting processing step, the base member 12 and the works are subjected to a cleaning step using the cleaning agent of the present embodiment, etc., the cleaning step being similar to the aforementioned second cleaning step 405, and then conveyed to the assembly step of the hard disk drive device 10.

The assembly step of the hard disk drive device 10 can be performed by using a publicly-known assembly technique. The assembly step of the hard disk drive device 10 is performed, for example, in a clean room. The clean room is filled with cleaned air and is adjusted so as to have a relatively positive pressure. The manufacturing step of a work is performed in a room adjusted so as to have a relatively negative pressure. By making the side of the assembly step of the hard disk drive device 10 to have a positive pressure, entry of a Particle into the assembly step side can be prevented, even when a Particle, detached from a work on the side of the manufacturing step of the work, is floating in the air. In the assembly step, the hard disk drive device 10 is assembled by using works having been subjected to a cleaning step using the cleaning agent of the present embodiment. In more detailed description, the hard disk drive device 10 is completed by mounting the bearing unit 30, the hub member 26 with which the yoke 27 and the magnet 46 are integrated, and the shaft 34, etc., onto the base member 12. Alternatively, when the assembly step of the hard disk drive device 10 is performed at a different timing, works having been subjected to all of the processing may be temporarily stored after being packed such that a foreign substance is not attached.

As described above, a method of manufacturing the hard disk drive device 10 according to the present embodiment comprises: cleaning at least one work by removing at least one of a fatty acid and a fatty acid ester, and a hydrocarbon, which are attached to the at least one work; and assembling the hard disk drive device by using the work having been subjected to the cleaning. Thereby, the cleanliness level of a work that forms the hard disk drive device 10 can be further enhanced. Accordingly, an amount of Particles that are attached to the recording disk 20 over time can be reduced. As a result, the read/write error can be reduced, and constituent parts of the hard disk drive device 10, which are suitable for large capacity of the hard disk drive device 10, can be provided. Further, the hard disk drive device 10 whose capacity can be made large can be provided. Furthermore, the life of the recording disk 20 can be extended, and finally the life of the hard disk drive device 10 can be extended.

In addition, a method of manufacturing the hard disk drive device 10 according to the present embodiment comprises: cleaning at least one work with a cleaning agent containing at least one of an ester and an ether, and a surfactant; and assembling the hard disk drive device by using the work having been subjected to the cleaning. Thereby, constituent parts of the hard disk drive device 10, which are suitable for large capacity of the hard disk drive device 10, can be provided, as stated above. Further, because a cutting agent component remaining on the surface of a work can be efficiently removed by using the cleaning agent of the present embodiment, a cleaning time can be shortened and a use amount of the cleaning agent can be reduced, etc., the workability in manufacturing the hard disk drive device 10 can be improved and the manufacturing cost thereof can be reduced.

It is needless to say that: the methods of manufacturing the hard disk drive device 10 and the hard disk drive device 10, according to the aforementioned embodiments, are exemplary only; and they only show the principle and the applications of the present invention. That is, the invention should not be limited to the aforementioned embodiments, and various modifications, such as design modifications, can be made with respect to the embodiments based on the knowledge of those skilled in the art, and an embodiment with such a modification can fall within the scope of the present invention. A new embodiment, in which a variation has been added to the aforementioned embodiments, has advantages of a combined embodiment and a varied embodiment.

In the aforementioned embodiments, the case where a work is formed through cutting processing has been described; however, they are not limited thereto, and a work may be formed, for example, through press processing. In this case, a work is contaminated with a fatty acid ester, a fatty acid, and a hydrocarbon, etc., which are derived from the press oil attached to a press processing machine. Or, when a die-cast product is used, as the base member 12, a work is contaminated with a fatty acid ester, a fatty acid, and a hydrocarbon, etc., which are derived from the oils and fats attached to a die-casting apparatus or cutting oil that can be used in trimming. According to a method of manufacturing the hard disk drive device 10 of the present embodiment, not only a fatty acid ester, a fatty acid, and a hydrocarbon, which are derive from cutting oil, but also a fatty acid ester, etc., derived from press oil and those attached to a production facility, such as a processing apparatus, can be removed from the surface of a work.

In the aforementioned embodiments, the case where all works are subjected to a cleaning step using the cleaning agent of the present embodiment has been described; however, they are not limited thereto, and at least one work may be subjected to the cleaning step using the cleaning agent of the present embodiment. By removing a fatty acid ester and a fatty acid, etc., from at least one work to enhance a cleanliness level, occurrences of read/write errors in the hard disk drive device 10 can be more reduced than before. Herein, as the number of works subjected to the cleaning step using the cleaning agent of the present embodiment becomes larger, occurrences of read/write errors can be naturally more reduced.

In the aforementioned embodiments, a cleaning step using the cleaning agent of the present embodiment (second cleaning step 405) is provided after the finish processing step 404; however, the embodiments are not limited thereto. The cleaning step using the cleaning agent of the present embodiment may be performed immediately after the cutting processing step 401 or the magnet attaching step 406. Alternatively, the first cleaning step 402, the third cleaning step 407, or the fourth cleaning step 408 may be the cleaning step using the cleaning agent of the present embodiment. The number of cleaning steps, a timing at which a cleaning step is performed, presence/absence of a cleaning agent, whether a conventional cleaning agent is used or the cleaning agent of the present embodiment is used, etc., may be appropriately set in accordance with a required cleanliness level of a work or a manufacturing time, etc.

In the aforementioned embodiments, the magnet 46 is attached to the hub member 26 via the yoke 27; however, a structure may be adopted, in which the magnet 46 is directly attached to the hub member 26.

### EXAMPLES

Hereinafter, examples of the present invention will be described, which do not intend to limit the scope of the invention, but are presented as preferred illustrative examples of the invention.

According to the compositions shown in Table 2, cleaning agent solutions of Examples 1 to 4 and Comparative Example were prepared. LEOCOL SC-90 (product name, made by Lion Corporation) was used for the alcohol ethylene oxide in Table 2.

TABLE 2

| | SURFACTANT | | COSOLVENT | | ORGANIC ACID | | WATER |
|---|---|---|---|---|---|---|---|
| | | PARTS | | PARTS | | PARTS | PARTS |
| | TYPE | BY MASS | TYPE | BY MASS | TYPE | BY MASS | BY MASS |
| EXAMPLE 1 | Laureth-7 | 150 | 2-METHYLPENTANEDIOIC | 100 | — | — | 300 |
| | | | ACID DIMETHYL ESTER | | | | |
| EXAMPLE 2 | Laureth-7 | 150 | 2-METHYLPENTANEDIOIC | 100 | LACTIC | 50 | 300 |
| | | | ACID DIMETHYL ESTER | | ACID | | |
| EXAMPLE 3 | Laureth-7 | 150 | GLUTARIC ACID | 100 | — | — | 300 |
| | | | DIMETHYL ESTER | | | | |
| EXAMPLE 4 | Laureth-7 | 150 | DIETHYLENE GLYCOL | 100 | — | — | 300 |
| | | | DIETHYL ETHER | | | | |
| COMPARATIVE | ALCOHOL | 1000 | 2-BUTOXYETHANOL | 100 | — | — | 300 |
| EXAMPLE | ETHYLENE OXIDE | | | | | | |

### (Cleaning Performance Evaluation Test)

The cleaning performance of each cleaning agent was evaluated by analyzing a Particle attached to the surface of a hub member cleaned with a cleaning agent solution of each of Examples 1 to 3 and Comparative Example with the use of gas chromatography/mass spectrometry. Specifically, the cleaning agent solution of each of Examples 1 to 3 and Comparative Example was first diluted with water, so that a diluted solution of each cleaning agent solution, which had a concentration of 1.0%, was prepared. The real concentrations of the cleaning agents (whole components excluding water in the diluted solution) in the diluted solutions were 0.45%, 0.5%, 0.45%, and 0.79%, respectively.

Three hub members, as samples, were immersed in a cleaning tank into which each of the obtained diluted solutions had been placed such that the hub members were cleaned with ultrasonic waves having a frequency of 40 kHz for 2 to 3 minutes at a solution temperature (cleaning temperature) of 55° C. Thereafter, a plurality of beakers into each of which 30 mL of hexane, as a solvent, had been placed were provided, and the samples after being cleaned were immersed therein. In addition, non-cleaned samples were provided and immersed in hexane in the same way as the other samples. The samples were left uncontrolled for 5 minutes while the hexane was being stirred, thereby obtaining liquids in each of which the Particles attached to the samples were extracted. Then, the samples were taken out from the extracted liquids. The surface of each sample was rinsed with 2 mL of hexane and the rinsing liquid was added to the extracted liquid. Thereafter, the hexane in the extracted liquid was evaporated, and 1 mL of hexane was newly added to the obtained dried extract. The extracted liquid was placed into a centrifuge tube to be concentrated. After the hexane in the extracted liquid in the centrifuge tube was evaporated with nitrogen gas, 100 μL of hexane was added to the obtained dried extract to dissolve the dried extract into the hexane again. This extracted liquid was transferred into a vial bottle for gas chromatography, and the hexane was evaporated. To the obtained dried extract, 50 μL of standard reagent anthracene-D10 in methylene chloride solution (2 ppm type) was added, which was used as an analysis sample.

The obtained analysis sample was analyzed by gas chromatography/mass spectrometry. For the analyses, Gaschromatograph (model number: 7890A GC, made by Agilent Technologies, Inc.) and mass spectrometer (model number 5975C MSD, made by Agilent Technologies, Inc.) were used. For the column, a fused silica glass tube, the inner wall of which is coated with 5% diphenyl-95% dimethylsiloxane and the outer surface of which is coated with polyimide, was used as a stationary phase. Nitrogen gas was used as a carrier gas. Settings of the gas chromatograph/mass spectrometer (GC/MS) are as follows:

Inlet temperature: 300° C.

Initial column temperature: 35° C.

Initial time: 1 minute

Temperature gradient: 15° C./min

Terminal temperature: 300° C.

Total execution time: Approximately 40 minutes

MSD auxiliary temperature: 300° C.

Mode: Splitless

Septum purge: 1 mL/min

Solvent delay: 4.5 minutes

Column flow: Approximately 1 mL/min

Sample injection volume: 3 mL/min,

Mass Range: 33 to 700 amu

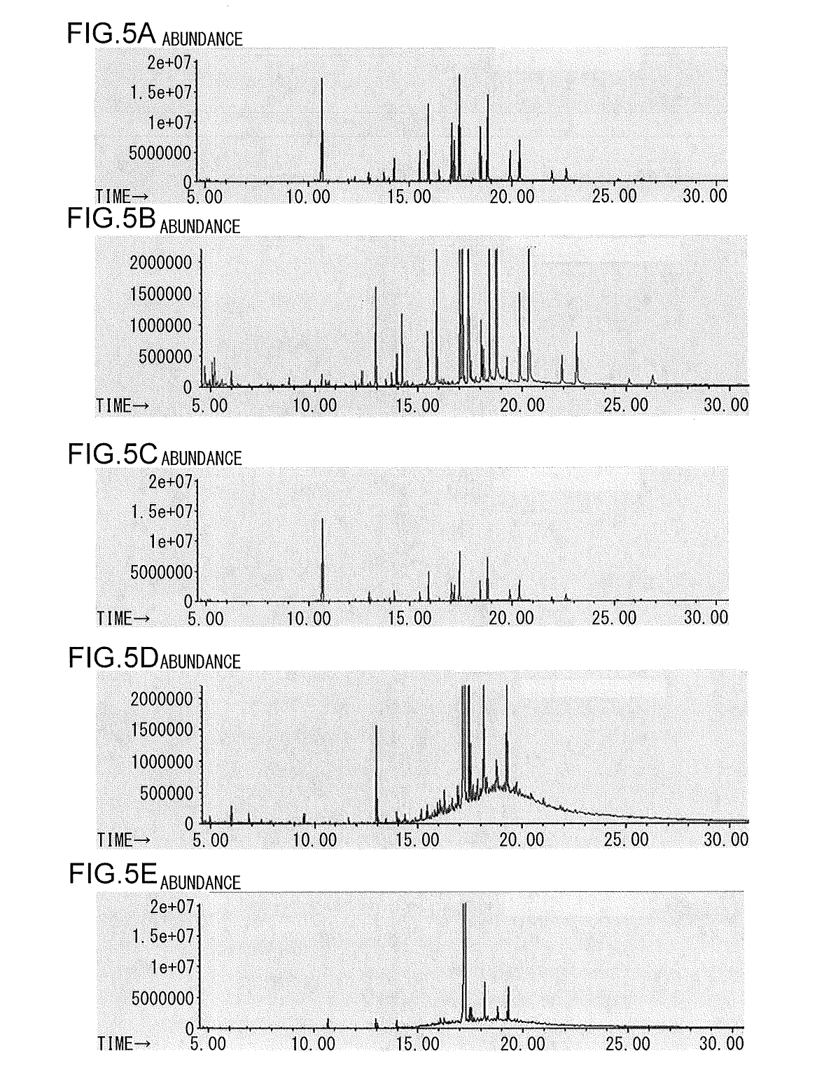

FIG. 5A is a chart showing a result of analyzing a sample, cleaned with a cleaning agent solution of Example 1, by gas chromatography/mass spectrometry. FIG. 5B is a chart showing a result of analyzing a sample, cleaned with a cleaning agent solution of Example 2, by gas chromatography/mass spectrometry. FIG. 5C is a chart showing a result of analyzing a sample, cleaned with a cleaning agent solution of Example 3, by gas chromatography/mass spectrometry. FIG. 5D is a chart showing a result of analyzing a sample, cleaned with a cleaning agent solution of Comparative Example, by gas chromatography/mass spectrometry. FIG. 5E is a chart showing a result of analyzing a non-cleaned sample by gas chromatography/mass spectrometry. In each of FIGS. 5A to 5E, the vertical axis represents peak intensity (abundance) and the horizontal axis represents retention time. An amount of Particles (ng/part) per a single hub member, a sample, was calculated by performing an integral treatment on the peaks of a chart shown in each of FIGS. 5A to 5E to measure a peak area. That is, the anthracene as a reference material was analyzed by gas chromatography/mass spectrometry along with a sample, and an analyzed value of the sample was converted into mass, based on the area of the anthracene. A cleaning agent solution of Example 4 was also analyzed by gas chromatography/mass spectrometry in the same way as in the cleaning agent solution of the aforementioned other Examples and Comparative Example, so that an amount of Particles (ng/part) per a single hub member was calculated from the obtained chart. Results are shown in Table 3.

TABLE 3

| | AMOUNT OF |
|---|---|
| | REMAINING PARTICLES |
| | (ng/part) |
| EXAMPLE 1 | 547 |
| EXAMPLE 2 | 924 |
| EXAMPLE 3 | 674 |
| EXAMPLE 4 | 415 |
| COMPARATIVE | 3075 |
| EXAMPLE | |
| NON-CLEANED | 13663 |

From FIGS. 5A to 5E and Table 3, each of the cleaning agent solutions of Examples 1 to 4 has a better cleaning performance in comparison with that of Comparative Example. Further, when a work is cleaned with the cleaning agent solution of Comparative Example, a plurality of peaks and a broad peak are observed, as shown in FIG. 5D. As a cause by which the broad peak is seen, it is considered that a large amount of fatty acids and fatty acid esters remain on the surface of a work, and these fatty acids and fatty acid esters interact with each other due to their polarities, and as a result, a broad difference is created among the molecular weights of Particles. On the other hand, when a work is cleaned with the cleaning agent solution of each of Examples 1 to 3, a broad peak is not observed, as shown in FIGS. 5A to 5C. From this, it is known that a fatty acid and a fatty acid ester can be removed from the surface of a work by using the cleaning agent of Examples 1 to 3. Herein, it can be considered that the observed peaks correspond to the hydrocarbons remaining on the surface of a work.

### (Cleaning Temperature Evaluation Test)

The cleaning agent solution of Example 1 was diluted with water, so that diluted solutions thereof respectively having a concentration of 0.5% and 1.0% were prepared. The real concentrations of the cleaning agent in the respective diluted solutions were 0.23% and 0.45%, respectively. Three cleaning tanks, into each of which the diluted solution having a concentration of 0.5% had been placed, were prepared, and three hub members, as samples, were immersed in each tank. The solution temperatures of the cleaning tanks were set to three different temperatures, specifically, to 45° C., 55° C., and 65° C., and the samples were cleaned with ultrasonic waves having a frequency of 40 kHz for 2 to 3 minutes. In addition, three hub members were immersed in the cleaning tank into which the diluted solution having a concentration of 1.0% had been placed such that they were cleaned with ultrasonic waves having a frequency of 40 kHz for 2 to 3 minutes at a solution temperature of 55° C. Thereafter, each sample was analyzed by gas chromatography/mass spectrometry in the aforementioned way, and from the obtained chart, an amount of Particles (ng/part) per single hub member was calculated. Results are shown in Table 4.

TABLE 4

| | AMOUNT OF | |
|---|---|---|
| | REMAINING PARTICLES | |
| | (ng/part) | |
| SOLUTION | 0.5% | 1.0% |
| TEMPERATURE | CONCENTRATION | CONCENTRATION |
| 45° C. | 576 | — |
| 55° C. | 674 | 547 |
| 65° C. | 702 | — |

From the results in Table 4 and those of the cases of non-cleaned and Comparative Example in Table 3, it has been known that, in the case of the diluted solution having a concentration of 0.5%, a good cleaning performance is exerted at a solution temperature of 45° C. to 65° C. Further, it has been known that, in the case of the diluted solution having a concentration of 1.0%, a good cleaning performance is exerted at a solution temperature of 55° C. In addition, because the diluted solution having a concentration of 0.5%, the concentration being low, has a good cleaning performance at solution temperatures of 45° C. and 65° C., it is expected that the diluted solution having a concentration of 1.0%, the concentration being higher, has also a good cleaning performance at solution temperatures of 45° C. and 65° C.

The invention according to the aforementioned embodiments may be specified by the following items.

(Item 1) A method of manufacturing a hard disk drive device including: a hub member on which a recording disk is to be mounted; and a base member configured to rotatably support the hub member via a bearing part, the method comprising: when constituent members including the base member, the hub member, and the bearing part are referred to as works, cleaning at least one of the works by using a cleaning agent containing at least one of an ester and an ether, and a surfactant in a mass ratio of the total of the ester and the ether to the surfactant of 1:1 to 1:4, in which at least one of a fatty acid and a fatty acid ester, and a hydrocarbon, which are attached to the at least one of the works, are removed; and assembling the hard disk drive device by using the work having been subjected to the cleaning.

(Item 2) The method of manufacturing a hard disk drive device according to Item 1, in which each of the ester and the ether contained in the cleaning agent has a molecular weight of 118 to 188.

(Item 3) The method of manufacturing a hard disk drive device according to Item 1 or Item 2, in which the cleaning includes contacting the work with an aqueous solution containing the cleaning agent and having a temperature of 70° C. or lower. (Item 4) The method of manufacturing a hard disk drive device according to any one of Items 1 to 3, in which the ester contains a fatty acid diester.

(Item 5) The method of manufacturing a hard disk drive device according to any one of Items 1 to 4, in which the cleaning agent further contains an organic acid.

(Item 6) The method of manufacturing a hard disk drive device according to any one of Items 1 to 4 comprising: cutting an unprocessed material while cutting agent is being supplied, to form the work, in which the fatty acid, the fatty acid ester, and the hydrocarbon are derived from the cutting agent.

(Item 7) A method of manufacturing a hard disk drive device including: a hub member on which a recording disk is to be mounted; and a base member configured to rotatably support the hub member via a bearing part, the method comprising: when constituent so members including the base member, the hub member, and the bearing part are referred to as works, cleaning at least one of the works with a cleaning agent containing at least one of an ester and an ether, and a surfactant; and assembling the hard disk drive device by using the work having been subjected to the cleaning.

(Item 8) A method of manufacturing a hard disk drive device including: a hub member on which a recording disk is to be mounted; and a base member configured to rotatably support the hub member via a bearing part, the method comprising: when constituent members including the base member, the hub member, and the bearing part are referred to as works, cleaning at least one of the works by removing at least one of a fatty acid and a fatty acid ester, and a hydrocarbon, which are attached to the at least one of the works; and assembling the hard disk drive device by using the work having been subjected to the cleaning.

(Item 9) A hard disk drive device manufactured by using the method of manufacturing a hard disk drive device according to any one of Items 1 to 8, the hard disk drive device comprising: a hub member on which a recording disk is to be mounted; and a base member configured to rotatably support the hub member via a bearing part.

1. A method of manufacturing a hard disk drive device including: a hub member on which a recording disk is to be mounted; and a base member configured to rotatably support the hub member via a bearing part, the method comprising:
when constituent members including the base member, the hub member, and the bearing part are referred to as works,
cleaning at least one of the works by using a cleaning agent containing at least one of an ester and an ether, and a surfactant in a mass ratio of the total of the ester and the ether to the surfactant of 1:1 to 1:4, in which at least one of a fatty acid and a fatty acid ester, and a hydrocarbon, which are attached to the at least one of the works, are removed; and
assembling the hard disk drive device by using the work having been subjected to the cleaning.

2. The method of manufacturing a hard disk drive device according to claim 1, wherein
each of the ester and the ether contained in the cleaning agent has a molecular weight of 118 to 188.

3. The method of manufacturing a hard disk drive device according to claim 1, wherein
the cleaning includes contacting the work with an aqueous solution containing the cleaning agent and having a temperature of 70° C. or lower.

4. The method of manufacturing a hard disk drive device according to claim 1, wherein
the ester contains a fatty acid diester.

5. The method of manufacturing a hard disk drive device according to claim 1, wherein
the cleaning agent further contains an organic acid.

6. The method of manufacturing a hard disk drive device according to claim 1 comprising:
cutting an unprocessed material while cutting agent is being supplied, to form the work, wherein
the fatty acid, the fatty acid ester, and the hydrocarbon are derived from the cutting agent.

7. A method of manufacturing a hard disk drive device including: a hub member on which a recording disk is to be mounted; and a base member configured to rotatably support the hub member via a bearing part, the method comprising:
when constituent members including the base member, the hub member, and the bearing part are referred to as works,
cleaning at least one of the works with a cleaning agent containing at least one of an ester and an ether, and a surfactant; and
assembling the hard disk drive device by using the work having been subjected to the cleaning.

8. The method of manufacturing a hard disk drive device according to claim 7, wherein
each of the ester and the ether contained in the cleaning agent has a molecular weight of 118 to 188.

9. The method of manufacturing a hard disk drive device according to claim 7, wherein
the cleaning includes contacting the work with an aqueous solution containing the cleaning agent and having a temperature of 70° C. or lower.

10. The method of manufacturing a hard disk drive device according to claim 7, wherein
the ester contains a fatty acid diester.

11. The method of manufacturing a hard disk drive device according to claim 7, wherein
the cleaning agent further contains an organic acid.

12. The method of manufacturing a hard disk drive device according to claim 7 comprising:
cutting an unprocessed material while cutting agent is being supplied, to form the work, wherein
the fatty acid, the fatty acid ester, and the hydrocarbon are derived from the cutting agent.

13. A method of manufacturing a hard disk drive device including: a hub member on which a recording disk is to be mounted; and a base member configured to rotatably support the hub member via a bearing part, the method comprising:
when constituent members including the base member, the hub member, and the bearing part are referred to as works,
cleaning at least one of the works by removing at least one of a fatty acid and a fatty acid ester, and a hydrocarbon, which are attached to the at least one of the works; and
assembling the hard disk drive device by using the work having been subjected to the cleaning.

14. The method of manufacturing a hard disk drive device according to claim 13, wherein
the cleaning includes cleaning the work with a cleaning agent containing at least one of an ester and an ether, and a surfactant.

15. The method of manufacturing a hard disk drive device according to claim 14, wherein
each of the ester and the ether contained in the cleaning agent has a molecular weight of 118 to 188.

16. The method of manufacturing a hard disk drive device according to claim 14, wherein
the ester contains a fatty acid diester.

17. The method of manufacturing a hard disk drive device according to claim 13, wherein
the cleaning includes contacting the work with a cleaning agent solution having a temperature of 70° C. or lower.

18. The method of manufacturing a hard disk drive device according to claim 13, wherein
the cleaning includes contacting the work with a cleaning agent solution containing an organic acid.

19. The method of manufacturing a hard disk drive device according to claim 13 comprising:
cutting an unprocessed material while cutting agent is being supplied, to form the work, wherein
the fatty acid, the fatty acid ester, and the hydrocarbon are derived from the cutting agent.
